(19) United States
(12) Patent Application Publication
(10) Pub. No.: US 2026/0089253 A1
(43) Pub. Date: Mar. 26, 2026

(54) TOOL FOR CONTROLLING DATA SPEEDS

(71) Applicant: T-MOBILE INNOVATIONS LLC, Overland Park, KS (US)

(72) Inventor: Raghavendra KULKARNI, Samamish, WA (US)

(21) Appl. No.: 18/893,514

(22) Filed: Sep. 23, 2024

(51) Int. Cl. H04M 1/72463; H04M 15/00; H04W 28/02

(52) U.S. Cl. CPC H04M 1/72463; H04M 15/886; H04W 28/0215

(57) ABSTRACT

Embodiments of the present disclosure are directed to systems and methods for controlling data speeds within a wireless telecommunications network system. This disclosure is meant to enable an end user to lower and/or raise the data speeds of certain devices and/or lines within a telecommunications plan that is under the control of the end user. In some examples, an end user may like to increase or decrease the data speeds of a certain device or line to better match the desired requirements for that device or line. When an end user limits or raises the data speeds of a device and/or line according to aspects of the present disclosure, the network may reutilize its resources to accommodate the change in data speeds and to maximize its available resources.

### SUMMARY

The present disclosure is directed to controlling data speeds within a wireless telecommunications network system, substantially as shown and/or described in connection with at least one of the Figures, and as set forth more completely in the claims.

According to various aspects of the technology, an end user may control the data speeds of devices and/or lines under a telecommunications plan within a cellular network. This disclosure is meant to enable an end user to lower and/or raise the data speeds of certain devices and/or lines within a telecommunications plan that is under the control of the end user. In certain conditions, an end user may like to increase or decrease the data speeds of a certain device or line to better match the desired requirements for that device or line. For example, if an end user has a child in grade school, and that child uses a device on the plan that is associated with the end user, then the end user may limit the data that the child can use on the device during school hours. In this example, because the data speeds have been limited by the parent (e.g., throttled), the child will not be able to do much on the device. In another example, if the end user is at a concert or sports game, the end user may desire to raise the data speeds during the time that the user is expected to be at the concert. When a user limits or raises the data speeds of a device and/or line according to aspects of the present disclosure, the network may reutilize its resources to accommodate the change in data speeds and to maximize its available resources.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a computing device for use with the present disclosure;

FIG. 2 illustrates a controlled data speeds engine in which implementations of the present disclosure may be employed;

FIG. 3 illustrates an example data controlling system in which implementations of the present disclosure may be employed;

FIG. 4 depicts a flow diagram of a method in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “mmWave” means RF waves having a wavelength measured in millimeters or fractions of millimeters (i.e., less than one cm), generally in the range of 30 GHz-3 THz, though frequencies above and below that range may still be used by aspects of the present disclosure.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, end users in a telecommunications carrier plan encompass various tools for managing and monitoring devices and/or lines associated with the telecommunications plan. For example, many devices have built-in parental controls. These controls can be applied at the device level by using built-in operating system features or third-party applications for setting screen time limits, blocking content, and/or managing application access. At the network level, routers and internet service providers offer content filtering, time management, and device control options to end users. Carrier-level controls through family plans and dedicated applications provide additional features like data monitoring and location tracking. Together, these tools help end users (e.g., parents) ensure safer and more responsible use of technology by other users on the plan (e.g., children).

Conventionally, while end users may limit internet usage, block content, and manage application access, there are no provisions in place for an end user to control data speeds on each of the devices or lines under his or her control in a telecommunications plan. Instead, the network data speeds are controlled by the carrier. For example, based on the specific plan that a customer (e.g., an end user) pays for, the carrier will provide data speeds at a certain rate, capping the data rate according to the agreed data rate under the plan that the customer pays for. When a customer is enrolled in a plan and wants to put restrictions on certain devices and/or lines associated with that plan, the customer currently does not have the ability to decrease and/or increase the data associated with the devices and/or lines on that plan. Instead, customers are only able to limit access to screen time, applications, and/or internet usage. As such, there is a need to allow end users the ability to employ some sort of time-based allocation of data speeds to certain devices and/or lines under the control of the end user.

Unlike conventional solutions, the present disclosure is directed to a tool for controlling data speeds in a telecommunications network. This disclosure is meant to enable an end user to lower and/or raise the data speeds of certain devices and/or lines within a telecommunications plan that is under the control of the end user. In certain conditions, an end user may like to increase or decrease the data speeds of a certain device or line to better match the desired requirements for that device or line. For example, if an end user has a child in grade school, and that child uses a device on the plan that is associated with the end user, then the end user may limit the data that the child can use on the device during school hours. In this example, because the data speeds have been limited by the parent (e.g., throttled), the child will not be able to do much on the device. In another example, if the end user is at a concert or sports game, the end user may desire to raise the data speeds during the time that the user is expected to be at the concert. When a user limits or raises the data speeds of a device and/or line according to aspects of the present disclosure, the network may reutilize its resources to accommodate the change in data speeds and to maximize its available resources.

Accordingly, a first aspect of the present disclosure is directed to a system for controlling data speeds within a wireless telecommunications network system. The system comprises one or more cellular networks configured to control data rate limits for one or more user devices within a cell site. The system further comprises one or more computer processing components configured to perform operations comprising receiving an instruction from a first device to change a first data rate limit at a second device to a second data rate limit. The operations further comprise determining that the first device has authority to request the instruction by querying one or more storage repositories. The operations further comprise, based on the determination that the first device has the authority, triggering the one or more cellular networks to dynamically impose a data restriction on the second device for a predetermined time period based on the instruction received from the first device. The operations further comprise, based on the predetermined time period elapsing, removing the data restriction on the second device.

A second aspect of the present disclosure is directed to a method for controlling data speeds within a wireless telecommunications network system. The method comprises receiving an instruction, at one or more cellular networks configured to control the data rates of one or more user devices within a cell site, from a first device to change a first data rate limit at a second device to a second data rate limit. The method further comprises determining that the first device has authority to request the instruction by querying one or more storage repositories. The method further comprises, based on the determination that the first device has the authority, triggering the one or more cellular networks to dynamically impose a data restriction on the second device for a predetermined time period based on the instruction received from the first device. The method further comprises, based on the predetermined time period elapsing, removing the data restriction on the second device.

Another aspect of the present disclosure is directed to a non-transitory computer readable media having instructions stored thereon that, when executed by one or more computer processing components, cause the one or more computer processing components to perform a method for controlling data speeds within a wireless telecommunications network system. The method comprises receiving an instruction, at one or more cellular networks configured to control the data rates of one or more user devices within a cell site, from a first device to change a first data rate limit at a second device to a second data rate limit. The method further comprises determining that the first device has authority to request the instruction by querying one or more storage repositories. The method further comprises, based on the determination that the first device has authority, triggering the one or more cellular networks to dynamically impose a data restriction on the second device for a predetermined time period based on the instruction received from the first device. The method further comprises reutilizing one or more network resources based on the second data rate limit. The method further comprises, based on the predetermined time period elapsing, removing the data restriction on the second device.

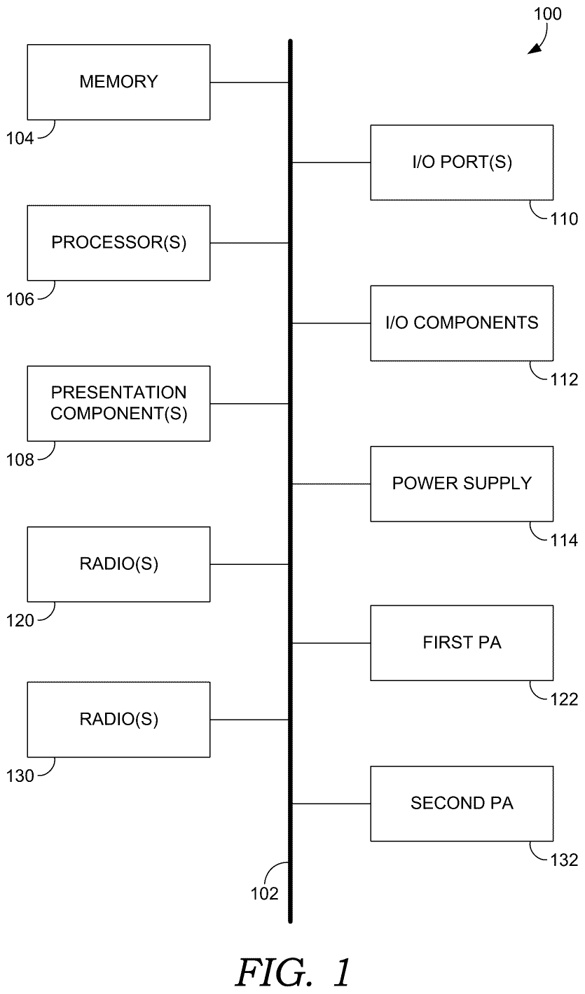

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

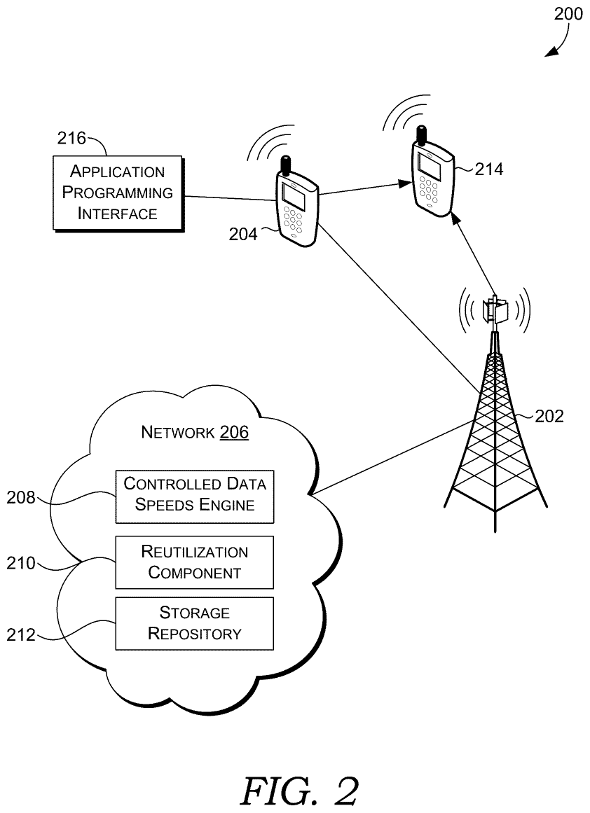

Turning now to FIG. 2, an exemplary network environment is illustrated in which implementations of the present disclosure may be employed. Such a network environment is illustrated and designated generally as network environment 200. At a high level, the network environment 200 comprises one or more UEs, one or more base stations, and one or more networks. Though a first UE 204 and a second UE 214 are illustrated as a cellular phone, a UE suitable for implementations with the present disclosure may be any computing device having any one or more aspects described with respect to FIG. 1. Similarly, though base station 202 is illustrated as a macro cell on a cell tower, any scale or form of access point acting as a transceiver station for wirelessly communicating with a UE, including small cells, pico cells, Wi-Fi access points (e.g., routers or mesh networks), and the like, are suitable for use with the present disclosure.

The network environment 200 comprises one or more base stations with which a UE may wirelessly communicate. The base station 202 comprises hardware and software components that allow it to wirelessly communicate with one or more UEs in one or more coverage areas. Each coverage area may be logically defined in space and frequency as one or more cells, which may or may not overlap. Using any radio access technology selected by a mobile network operator (e.g., 4G, 5G, 6G, 802.11x, and the like), the base station may transmit and receive wireless signals using one or more antenna elements.

Each base station of the one or more base stations may be associated with one or more at least partially distinct networks, wherein each network is associated with one or more network identifiers. Each network, such as network 206, may be a telecommunications network(s) (e.g., a packet data network or core network), data network, or portions thereof. A telecommunications network that at least partially comprises the network environment 200 may include additional devices or components (e.g., one or more base stations) not shown. Those devices or components may form network environments similar to what is shown in FIG. 2, and may also perform methods in accordance with the present disclosure. Components such as terminals, links, and nodes (as well as other components) may provide connectivity in various implementations.

In order to control data speeds within a wireless telecommunications network system, the network environment comprises a controlled data speeds engine 208. Though illustrated as a dedicated engine within a network, the controlled data speeds engine 208 is described herein by way of its functionality and may be deployed or implemented in various ways that are consistent with the functionality described herein. For example, the controlled data speeds engine 208 may take the form of one or more computer processing components at or near the base station 202 executing computer executable instructions that cause the one or more computer processing components to perform the operations described herein. The controlled data speeds engine 208 may be said to interact with a storage repository 210, a reutilization component 212, and an application programming interface (API) 216.

The controlled data speeds engine 208 is configured to enable end users to lower (e.g., decrease, reduce, limit, restrict, etc.) and/or raise (e.g., increase, boost, etc.) data speeds of a certain device or line associated with a telecommunications carrier plan that is under the control of the end user (e.g., owner of an account, primary account holder, etc.). As such, the controlled data speeds engine 208 allows an end user to change the data speeds (e.g., data rates) of a device or line to better match the end user's requirements for that device or line. For example, if an end user has a child in grade school, and that child uses a device on the plan associated with the end user (e.g., a $30 plan, $50 plan, $100 plan, and/or any other type of plan), the end user may want to limit the data rate that the child can use while on the device during school hours. In this example, the child will not be able to do much on the device due to the throttled data speeds facilitated by the controlled data speeds engine 208. In another example, if an end user is at a concert or sporting event, the end user may desire to raise the data speeds during the time that the end user is expected to be at the concert in an attempt to combat the slower service associated with a higher congestion level of the cellular band and/or the cell towers (e.g., base stations). In this example, the controlled data speeds engine 208 may facilitate the raising of the data speeds for the end user.

In some embodiments, the controlled data speeds engine 208 may be employed based on a handset capability of a user device, such as the first UE 204. For example, the controlled data speeds engine 208 may interact with the API 216 of the first UE 204. In some embodiments, the API 216 may be an application and/or a settings feature of the first UE 204 that enables a user of the first UE 204 (e.g., an end user) to lower or raise the data speeds of a specific device and/or line, such as the second UE 214. For example, an end user may act as an account administrator for an account comprising a plurality of lines, and the end user may control (e.g., effectuate) the data restrictions of the second UE 214 using the first UE 204. In other words, an end user may use the first UE 204 to effectuate restrictions on a device or line (e.g., such as the second UE 214) associated with an account under the control of the end user. Accordingly, the API 216 may interact with the controlled data speeds engine 208 to facilitate an end user's request to lower or raise data speeds on a specific device and/or line. For example, based on an end user's telecommunications plan (e.g., a data plan), the end user may request that a device receive slower data speeds (e.g., quantifiable data, such as 2 GB, 10 GB, 100 GB, etc.) during certain hours, and the network 206 (e.g., via the controlled data speeds engine 208) may complete the request within the parameters of the end user's account (e.g., the limits of the end user's telecommunications plan).

In some embodiments, telecommunication carriers may enforce the lowering and raising of data speeds as instructed by an end user. For example, an end user could have a $100 plan that includes unlimited data until 30 GB is reached on any given line included in the plan, and beyond 30 GB, then other parameters may be instituted (e.g., such as lower data speeds, for example). Continuing the example, outside of implementation of the present disclosure by the end user, the users of any given line on the telecommunications plan of the end user may experience no restrictions until the 30 GB threshold is met. In this example, under implementation of the current disclosure, the end user may enforce certain usage of data for a predetermined time period for any line associated with the end user's plan, and the enforced usage of data may be outside the normal parameters of the plan (e.g., 30 GB, in this example). In other words, the present disclosure grants an end user the capability to determine the bandwidth or data prioritization for individual devices and lines on the end user's plan.

In some aspects, via the API 216, an end user may manually determine the amount of data that the end user desires a specific device on the end user's plan to receive during a certain time period. In some examples, an end user can set the time period to occur at certain hours (e.g., from 7 AM-4 PM, for example) and at a certain time interval (e.g., such as daily, weekly, on weekdays, and any other configurable time interval). For example, if an end user's child is in school or the end user is going on a road trip with a child on the plan, the end user may want to limit the data speeds of the child's device in order for the child to focus in school or for the child spend quality time with the end user. As such, a predetermined time period (e.g., set by the end user) may be repeated at a time interval that is a specified measurement of time that elapses before repeating the predetermined time period. Accordingly, in addition to data consumption capabilities, the present disclosure is based on a time-bound approach.

As such, an end user can essentially put a check and balance on a device or line in which the device or line is not permitted to use a certain amount of data at a predetermined time period during the day (e.g., set by the user in the application or the settings of a user device via the API 216), but outside of that predetermined time period, the device or line may utilize the normal amount of data associated with the end user's plan. In an example, if an end user has a plan with high data rates, and the end user would like to increase or decrease the data rates during a specified time period (e.g., specified by the end user via the API 216), then the end user may do so. For example, the telecommunications plan may include a high bit rate data plan, but the end user would like to reduce the data speeds to a low bit rate for a certain amount of time. In this example, the end user may have the capability to restrict the data speeds during a predefined time period by submitting an instruction to do so through the API 216 to the controlled data speeds engine 208 of the network 206 (e.g., the end user's instruction is input to the controlled data speeds engine 208). In some aspects, when the predetermined time period (e.g., set by the end user) elapses, the data speeds of the device or line that was altered by the end user reverts back to its original data speeds (e.g., the data speeds agreed under the telecommunications plan).

In an example, an end user may have 4 lines that are assigned to family members. In this example, for whatever reason, the end user may want to limit or raise the data speeds for a certain line during a certain time period. Accordingly, through the API 216 of UE 204, the end user may instruct the network 206, via the controlled data speeds engine 208, to perform this function (e.g., limit or raise the data speeds allocated to the certain line for a certain time period). In this way, the present disclosure may be a soft enforcement of data being distributed and utilized across a plan (e.g., data throttling, in some examples).

In some aspects, an end user must have authority in order to instruct the network 206 to increase or a decrease the data speeds for a certain device or line. As such, in some embodiments, the controlled data speeds engine 208 may receive an instruction (e.g., to change the data rate of a device and/or line) from a user via the API 216, and the controlled data speeds engine 208 may determine that the user has authority to request the instruction by querying the storage repository 210. In some examples, the storage repository 210 is a database that may contain, among other things, data associated with end users who are authorized to increase or decrease data speeds for certain devices and/or lines in a telecommunications plan. As such, in some examples, the controlled data speeds engine 208 may reference a number of network plans stored within the storage repository 210, determine that the device and/or line subject to a potential change in data speeds belongs to one network plan within the number of network plans; and determine that an end user is associated with the device and/or line and the end user has the authority to instruct the network to change the data speeds for the device and/or line. In some examples, an end user (e.g., associated with the first UE 204) may only be authorized to instruct the network to change the data speeds for a device and/or line (e.g., the second UE 214) if the device and/or line is associated with a minor child. Accordingly, an end user may only increase or decrease data speeds of a device or line via the API 216 if the end user is authorized to do so.

In some examples when it is determined that an end user has authority to request an instruction for the controlled data speeds engine 208 to increase or decrease data speeds for a certain device and/or line, the end user may send the instruction to the network 206 (e.g., via controlled data speeds engine 208) to limit or raise the data speeds of the certain device and/or line, and the network 206 may change the data rates depending on the availability of network 206. For example, the network 206 might not have the capability to limit or raise data speeds for a certain device or line during certain hours. In some examples, an end user may be able to determine, via the API 216, whether or not the network 206 is available to change the data speeds at the time desired by the end user. In other words, an end user may see, via the API 216, whether or not the end user has the capability to request an instruction to limit or raise data speeds at that time. Similarly, an end user may be able to see, via the API 216, when the network 206 is capable of limiting or raising data speeds at the specific time(s) that the end user would like to raise or limit the data speeds for a certain device or line within the end user's telecommunications plan.

In some embodiments, after an end user sends an instruction to the controlled data speeds engine 208 to limit or raise the data speeds for a device or line, the controlled data speeds engine 208 may determine how to achieve that request while reutilizing network resources. In other words, receiving an instruction to increase or decrease data rates from an authorized end user may trigger the controlled data speeds engine 208 to dynamically impose a data restriction (e.g., changing a data rate limit from a first data rate limit to a second data rate limit) on a device or line for a predetermined time period based on the instruction received from the authorized end user. For example, the first UE 204 may instruct the network 206 to dynamically impose a data restriction on the second UE 214 for a certain amount of time on a given day. In this example, during that amount of time on that given day, a data utilization of the second UE 214 will change from a first data rate limit to a second date rate limit based on the instruction received from the first UE 204. In some examples, when the controlled data speeds engine 208 fulfills the instruction received from an end user, the reutilization component 212 may redistribute network resources based on the authorized end user's request (e.g., during the predetermined time period associated with the instruction received from the end user). As such, once an end user determines how the end user wants to limit or raise data speeds for a specific device or line, then the reutilization component 212 of the network 206 may determine how to redistribute network resources amongst other devices, lines, and/or users. In some aspects, once the predetermined time period associated with the instruction received from the end user elapses, the data restriction is removed (e.g., the data utilization reverts from the second data rate limit back to the first data rate limit).

In some examples, certain key performance indicators (KPIs) may be required to occur so that the feature (e.g., the lowering and/or raising of data speeds) can be deployed and/or enabled by the controlled data speeds engine 208, and so that the network 206 may reapportion resources appropriately after altering the data speeds for a certain device and/or line. For example, a telecommunications carrier may make use of some performance indices to determine the capabilities of a particular cell so that users within that cell can utilize the full capacity of the cell for some other purpose after the data rates for a certain device or line have been changed based on the instruction received from an end user. In some examples, KPIs relevant to utilize the controlled data speeds engine 208 may include, but are not limited to, network through put (e.g., the total amount of data transmitted successfully over the network in a given time period), bandwidth utilization (e.g., the ration of used bandwidth to the total available bandwidth), latency, packet loss, jitter, network load (e.g., the total amount of traffic currently on the network), and network congestion levels (e.g., the periods or areas of the network experiencing congestion). For example, if the network load and/or the network congestion levels are high (e.g., substantially higher than expected), the network 206 may use those KPIs to determine that the controlled data speeds engine 208 may not be used at that point in time (e.g., an end user may not instruct the network 206 to lower or raise the data speeds for a specific device or line). In some aspects, if the KPIs indicate that an end user has the capabilities to instruct the network 206 to lower or raise the data speeds for a specific device or line, the network 206 may still utilize the KPIs in determining how best to reapportion network resources.

Accordingly, the reutilization component 212 may utilize network resources for other purposes, such as enhancing the services of other users in a cell. In an example, the same cell site that is serving an area in which an end user is located may provide services at a predetermined data speed. In this example, a sliced network may exist that provides service to that particular domain of operation. However, when an end user determines that the end user would like the data speeds of a certain device or line to be increased or decreased, then the resources of the network 206 may be reutilized by the reutilization component 212 in a way to achieve the request of the end user and still serve other devices in the cell site. For example, the network 206 may reutilize its resources to better process more complex requests for other users in need (e.g., fulfilling a call in the cell zone to first responders which may require higher data rates for a video call or location tracking, for example).

As can be seen, in some examples, if the data speeds of a certain device or line are being used in accordance with the instruction received from an end user, the network 206 may adapt to the end user's instruction and reapportion data speeds and resources accordingly. For example, if there are 100 devices located within a cell site that is in a school zone (e.g., cell phones associated with grade school students), and end users associated with those 100 devices (e.g., the parents of the grade school students) request a decrease in the data speeds for many of those devices during school hours, then the network servicing that cell site (e.g., such as network 206) may reallocate its resources. For instance, the reutilization component 212 of network 206 may reutilize the available resources for anything that may involve giving more hint (e.g., insights into network conditions or configurations, helping to improve performance and resource allocation, and/or suggestions into optimal routing paths for data based on current network conditions or historical data), hint subscriptions (e.g., dynamically adjusting network behavior or configurations based on real-time information and/or optimizing resource usage, such as bandwidth or processing power, based on the hints provided about current or predicted network demands), and any other type of utilization of resources. In some aspects, end users controlling data speeds may give their carrier a better radio/network utilization.

In some embodiments, carriers may track an end user's data requests (e.g., instructions), determine a pattern in the data usage of devices and/or lines associated with the end user's plan, and optimize their offerings according to the pattern of the end user's data requests. For example, the carrier may give out a hint service. As such, network resources can be re-distributed by the reutilization component 212 based on a pattern representing the end user's requirements. In other words, the reutilization component 212 of the network 206 may rely on the identification of an end user's requests to automatically decrease or increase data speeds to anticipate redistribution of resources in the future.

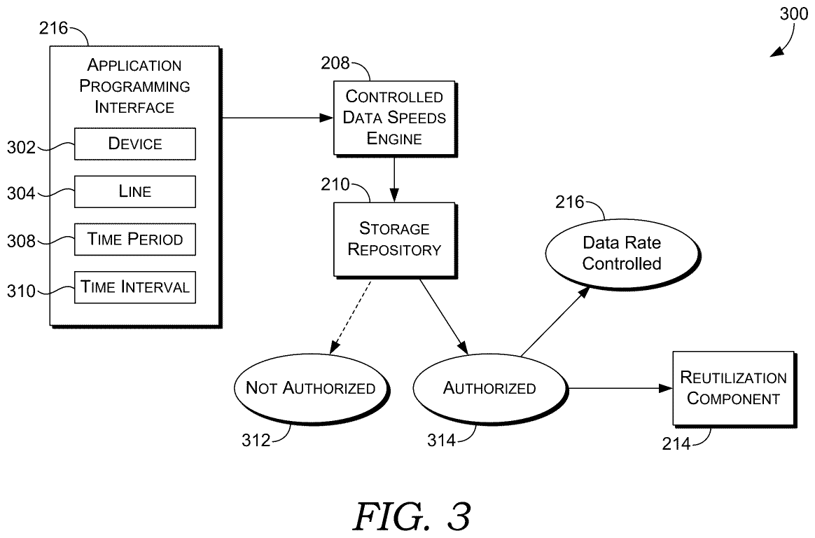

Turning now to FIG. 3, an example of a data controlling system 300 is provided. The data controlling system visually illustrates controlling data speeds within a wireless telecommunications network system. In some examples, an end user may input a request, via API 216, to instruct the controlled data speeds engine 208 to increase or decrease data rates for a device 302 and/or a line 304 under a telecommunications plan for a time period 308 and/or a time interval 310. For example, if an end user's child is in school and the end user wants to limit the data speeds of the child's device (e.g., the device 302) in order for the child to focus in school, the end user may request an instruction for the controlled data speeds engine to limit the data speeds for the child's device for the time period 308 from 7 AM-4 PM for the time interval 310 of weekdays. In this example, when the controlled data speeds engine 208 receives the request from the end user, the controlled data speeds engine 208 may interact with the storage repository 210 to determine if the end user is authorized to request the instruction. If the user is a not authorized 312 user, then the user may not instruct the controlled data speeds engine 208 to change the data rate of the device 302. If the user is an authorized 314 end user, then the end user may instruct the controlled data speeds engine 208 to change the data rate of the device 302. In this second scenario (e.g., the end user is an authorized 314 end user), when the cellular network receives the instruction from the end user to limit the data speeds of the child's device, the network is triggered to dynamically change the data rate of the child' device to for the predetermine time period (e.g., 7 AM-4 PM) and predetermined time interval (e.g., weekdays) based on the instruction received from the end user via the API 216. As such, the child's device may experience a data rate controlled 316 until the predetermined time period elapses, when the data rate is reverted back to the data rate before the instruction from the end user was received at the network. Furthermore, when the cellular network receives the instruction from the end user to limit the data speeds of the child's device, the reutilization component 212 may determine how to redistribute network resources amongst other devices, lines, and/or users. In some examples, triggering the cellular networks to dynamically change the data rate of a device and/or line causes a policy and charging rules function (PCRF) to change a quality of service (QoS) level and a bandwidth effect for the device and/or line.

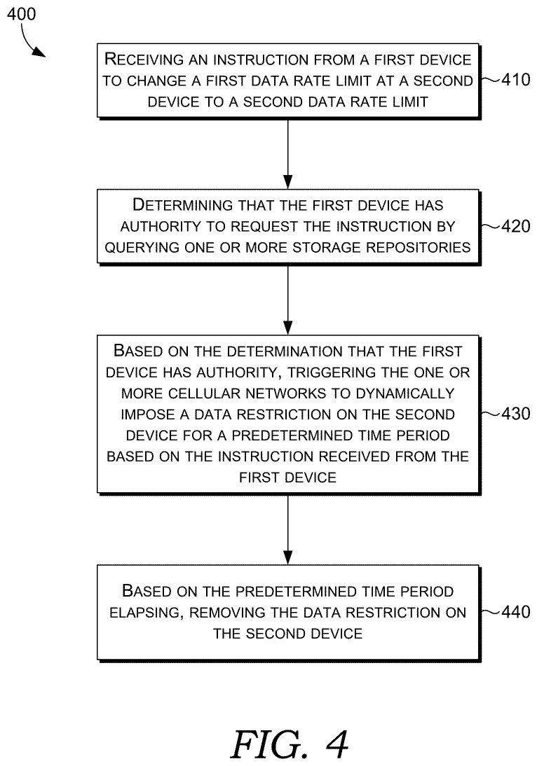

Turning now to FIG. 4, a flow chart representing a method 400 is provided. Generally the method 400 may be used by a network, such as the network 206 FIG. 2, and/or a base station, such as the base station 202 of FIG. 2, to control data speeds within a wireless telecommunications network system. At a first step 410, the network receives an instruction from a first device to change a first data rate at a second device to a second data rate, according to any one or more aspects described with respect to FIGS. 2-3. At a second step 420, the network determines that the first device has authority to request the instruction by querying one or more storage repositories, according to any one or more aspects described with respect to FIGS. 2-3. At a third step 430, based on the determination that the first device has authority, the network triggers the one or more cellular networks to dynamically change the first data rate at the second device to the second data rate for a predetermined time period based on the instruction received from the first device, according to any one or more aspects described with respect to FIGS. 2-3. At a step 440, based on the predetermined time period elapsing, the network reverts the data rate at the second device from the second data rate back to the first data rate, according to any one or more aspects described with respect to FIGS. 2-3.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for controlling data speeds within a wireless telecommunications network system, the system comprising:
one or more cellular networks configured to control data rate limits for one or more user devices within a cell site; and
one or more computer processing components configured to perform operations comprising:
receiving an instruction from a first device to change a first data rate limit at a second device to a second data rate limit;
determining that the first device has authority to request the instruction by querying one or more storage repositories;
based on the determination that the first device has the authority, triggering the one or more cellular networks to dynamically impose a data restriction on the second device for a predetermined time period based on the instruction received from the first device; and
based on the predetermined time period elapsing, removing the data restriction on the second device.

2. The system of claim 1, wherein the instruction is input into an application of the first device, wherein the instruction includes the predetermined time period.

3. The system of claim 1, wherein the instruction is input into a user setting of the first device, wherein the instruction includes the predetermined time period.

4. The system of claim 1, wherein the predetermined time period may be repeated at a time interval, the time interval comprising a specified measurement of time that elapses before repeating the predetermined time period.

5. The system of claim 1, wherein the first data rate limit is higher than the second data rate limit.

6. The system of claim 1, wherein the first data rate limit is lower than the second data rate limit.

7. The system of claim 1, wherein querying the one or more storage repositories comprises:
referencing a plurality of network plans stored within the one or more storage repositories;
determining that the first device and the second device belong to one network plan within the plurality of network plans; and
determining that an end user is associated with the first device, wherein the end user has the authority to request the instruction.

8. The system of claim 1, wherein imposing the data restriction comprises limiting a data utilization to the second data rate limit, and wherein removing the data restriction comprises reverting the data utilization to the first data rate limit.

9. The system of claim 8, the operations further comprising reutilizing one or more network resources based on the second data rate limit prior to removing the data restriction.

10. The system of claim 1, wherein triggering the one or more cellular networks to dynamically change the first data rate at the second device to the second data rate causes a policy and charging rules function (PCRF) to change a quality of service (QoS) level and a bandwidth effect for the second device.

11. A method for controlling data speeds within a wireless telecommunications network system, the method comprising:
receiving an instruction, at one or more cellular networks configured to control the data rates of one or more user devices within a cell site, from a first device to change a first data rate limit at a second device to a second data rate limit;
determining that the first device has authority to request the instruction by querying one or more storage repositories;
based on the determination that the first device has the authority, triggering the one or more cellular networks to dynamically impose a data restriction on the second device for a predetermined time period based on the instruction received from the first device; and
based on the predetermined time period elapsing, removing the data restriction on the second device.

12. The method of claim 11, wherein the predetermined time period may be repeated at a time interval, the time interval comprising a specified measurement of time that elapses before repeating the predetermined time period.

13. The method of claim 11, wherein the first data rate limit is higher than the second data rate limit.

14. The method of claim 11, wherein the first data rate limit is lower than the second data rate limit.

15. The method of claim 11, wherein querying the one or more storage repositories comprises:
referencing a plurality of network plans stored within the one or more storage repositories;
determining that the first device and the second device belong to one network plan within the plurality of network plans; and
determining that an end user is associated with the first device, wherein the end user has the authority to request the instruction.

16. The method of claim 11, wherein imposing the data restriction comprises limiting a data utilization to the second data rate limit, and wherein removing the data restriction comprises reverting the data utilization to the first data rate limit.

17. The method of claim 11, the method further comprising reutilizing one or more network resources based on the second data rate limit prior to removing the data restriction.

18. The method of claim 11, wherein triggering the one or more cellular networks to dynamically change the first data rate at the second device to the second data rate causes a policy and charging rules function (PCRF) to change a quality of service (QoS) level and a bandwidth effect for the second device.

19. A non-transitory computer readable media having instructions stored thereon that, when executed by one or more computer processing components, cause the one or more computer processing components to perform a method for controlling data speeds within a wireless telecommunications network system, the method comprising:
receiving an instruction, at one or more cellular networks configured to control the data rates of one or more user devices within a cell site, from a first device to change a first data rate limit at a second device to a second data rate limit;
determining that the first device has the authority to request the instruction by querying one or more storage repositories;
based on the determination that the first device has authority, triggering the one or more cellular networks to dynamically impose a data restriction on the second device for a predetermined time period based on the instruction received from the first device;
reutilizing one or more network resources based on the second data rate limit; and
based on the predetermined time period elapsing, removing the data restriction on the second device.

20. The non-transitory computer readable media of claim 19, wherein imposing the data restriction comprises limiting a data utilization to the second data rate limit, and wherein removing the data restriction comprises reverting the data utilization to the first data rate limit.
